(19) United States
(12) Patent Application Publication
(10) Pub. No.: US 2019/0385542 A1
(43) Pub. Date: Dec. 19, 2019

(54) A DISPLAY METHOD AND DEVICE OF REDUCING THE BLUE LIGHT

(71) Applicant: Wuhan China Star Optoelectronics Technology Co., Ltd, Wuhan, Hubei (CN)

(72) Inventor: Yong YANG, Wuhan, Hubei (CN)

(21) Appl. No.: 15/579,119

(22) PCT Filed: Nov. 21, 2017
(86) PCT No.: PCT/CN2017/112126

§ 371 Date: Dec. 1, 2017

(30) Foreign Application Priority Data
Oct. 31, 2017 (CN) 201711049430.2

(51) Int. Cl. G09G 3/34

(52) U.S. Cl. CPC G09G 3/3406; G09G 2360/144; G09G 3/36; G09G 2360/141; G09G 2320/0626

(57) ABSTRACT

The present invention provides a display method of reducing the blue light of a display device which comprises detecting an ambient brightness, determining if the ambient brightness is lower than a threshold value, and reducing a blue light ratio of the display device if the ambient brightness is lower than the threshold value for making an whiteness index of the display fall on the blackbody curve of CIE chart.

The method of reducing display blue light of the present invention reduces the blue light ratio of the display when it is detected that the brightness of the ambient light is less than a predetermined threshold and causes the white point coordinates of the display to be located on the black body locus of the CIE chromaticity diagram. It reduces the short-wave blue light energy hazards while achieving the health of the monitor eye and minimizing perceived human color cast,

### RELATED APPLICATIONS

The present application is a National Phase of International Application Number PCT/CN2017/112126, filed Nov. 21, 2017, and claims the priority of China Application 201711049430.2, filed Oct. 31, 2017.

### FIELD OF THE DISCLOSURE

The present invention relates to the field of liquid crystal display technology, and in particular, to a display method and device of reducing blue light.

### BACKGROUND

With the development of Thin Film Transistor-Liquid Crystal Displays (TFT-LCD), liquid crystal displays are widely used in various fields. The liquid crystal display will emit blue light when displaying the image, and it has reached consensus that the blue light will cause human eye fatigue and injury in the medical field. The small size products in the market mostly adopt the software control mode to reduce the short-wave blue light emitted by the liquid crystal display now-days. However, for the software control mode of most small-size panels, it appears the yellow phenomenon of the screen, and makes the minority people feel sick and vomit. Therefore, it has become a challenge that many terminal manufacturers need to face that how to design a better software control mode to control the blue light in a small size panel without causing obvious optical changes.

### SUMMARY

In order to solve the shortcomings of the prior art, the present invention provides a method and a device for reducing blue light of a display, which can meet human visual characteristics.

The present invention provides a display method of reducing the blue light of a display device which comprises:

detecting an ambient brightness;

determining if the ambient brightness is lower than a threshold value;

reducing a blue light ratio of the display device if the ambient brightness is lower than the threshold value for making an whiteness index of the display fall on the blackbody curve of CIE chart.

Optionally, the step of reducing the blue light ratio if the ambient brightness is lower than the threshold value which further comprises:

determining the ambient brightness is within a first brightness range, and lowering the blue light ratio of the display device to a first ratio when the ambient brightness is tot first brightness range;

determining the ambient brightness is within a second brightness range, and lowering the blue light ratio of the display device to a second ratio when the ambient brightness is within the second brightness range;

determining the ambient brightness is within a third brightness range, and lowering the blue light ratio of the display device to a third ratio when the ambient brightness is within the third brightness range;

determining the ambient brightness is within a fourth brightness range, and lowering the blue light ratio of the display device to a fourth ratio when the ambient brightness is within the fourth brightness range; and

determining the ambient brightness is within a fifth brightness range, and lowering the blue light ratio of the display device to a fifth ratio when the ambient brightness is within the first brightness range.

Optionally, the method further comprises:

the step of lowering the blue light ratio of the display device to the first ratio when the ambient brightness is within the first brightness range which further comprises lowering the brightness of blue light of the display device to a first brightness and lowering the of a green light of the display device a second brightness;

the step of lowering the blue light ratio of the display device to the second ratio when the ambient brightness is within the second brightness range which further comprises lowering the brightness of blue light of the display device to a third brightness and lowering the of a green light of the display device a fourth brightness;

the step of lowering the blue light ratio of the display device to the third ratio when the ambient brightness is within the third brightness range which further comprises lowering the brightness of blue light of the display device to a fifth brightness and lowering the of a green light of the display device a sixth brightness;

the step of lowering the blue light ratio of the display device to the fourth ratio when the ambient brightness is within the fourth brightness range which further comprises lowering the brightness of blue light of the display device to a seventh brightness and lowering the of a green light of the display device a eighth brightness; and

the step of lowering the blue light ratio of the display device to the fifth ratio when the ambient brightness is within the fifth brightness range which further comprises lowering the brightness of blue light of the display device to a ninth brightness and lowering the of a green light of the display device a tenth brightness.

Optionally, the blue light of the display device with the wavelength is in the range of 430 nm-480 nm, and the green light of the display device with the wavelength is in the range of 510 nm-570 nm.

Optionally, the first brightness range is 300-500 lux, and the second brightness range is 100-300 lux. The third brightness range is 50-100 lux. The fourth brightness range is 10-50 lux, and the fifth brightness range is 0-10 lux.

Optionally, the first ratio is 2.93%, and the second ratio is 2.56%. The third ratio is 1.94%. The fourth ratio is 1.44% and the fifth ratio is 1.06%.

Optionally, the first brightness is 0.87-0.95 time of the brightness of he blue light of the display, and the second brightness is 0.93-0.95 time of the brightness of the green light of the display. The third brightness is 0.69-0.7 time of the brightness of the blue light of the display. The fourth brightness is 0.86-0.88 time of the brightness of the green light of the display; and the fifth brightness is 0.43-0.48 time of the brightness of the blue light of the display. The sixth brightness is 0.67-0.75 time of the brightness of the green light of the display, and the seventh brightness is 0.27-0.32 time of the brightness of the blue light of the display. The eighth brightness is 0.55-0.61 time of the brightness of the green light of the display. The ninth brightness is 0.17-0.22 time of the brightness of the blue light of the display, and the tenth brightness is 0.43-0.48 time of the brightness of the green light of the display.

Optionally, the threshold value is 500 lux.

The present invention provides a low blue light display device which comprises:

a detecting module which is used for detecting an ambient brightness;

a determining module which is used for determining if the ambient brightness is lower than a threshold value;

a adjusting module which is used for lowering a blue light ratio of the display device when the ambient brightness is lower than the threshold value to make the whiteness index of the display device that is on the blackbody curve of the CIE chart.

The method of reducing display blue light of the present invention reduces the blue light ratio of the display when it is detected that the brightness of the ambient light is less than a predetermined threshold and causes the white point coordinates of the display to be located on the black body locus of the CIE chromaticity diagram. It reduces the short-wave blue light energy hazards while achieving the health of the monitor eye and minimizing perceived human color cast,

### BRIEF DESCRIPTION OF THE DRAWINGS

FIG. 1 is a flow chart of a method of reducing display blue light;

FIG. 2 is a schematic diagram of light intensity corresponding to different wavelengths of light;

FIG. 3 is a coordinate of the white index of the display;

FIG. 4 is a schematic diagram of a device for reducing blue light of a display.

### DETAILED DESCRIPTION OF PREFERRED EMBODIMENTS

Hereinafter, embodiments of the present invention will be described in detail with reference to the accompanying drawings. However, the invention may be embodied in many different forms and should not be construed as limited to the specific embodiments set forth herein. Rather, these embodiments are provided to explain the principles of the invention and its practical application to enable those of ordinary skill in the art to understand various embodiments of the invention and various modifications as are suited to the particular use contemplated. In the drawings, the same reference numerals will always be used to refer to the same elements.

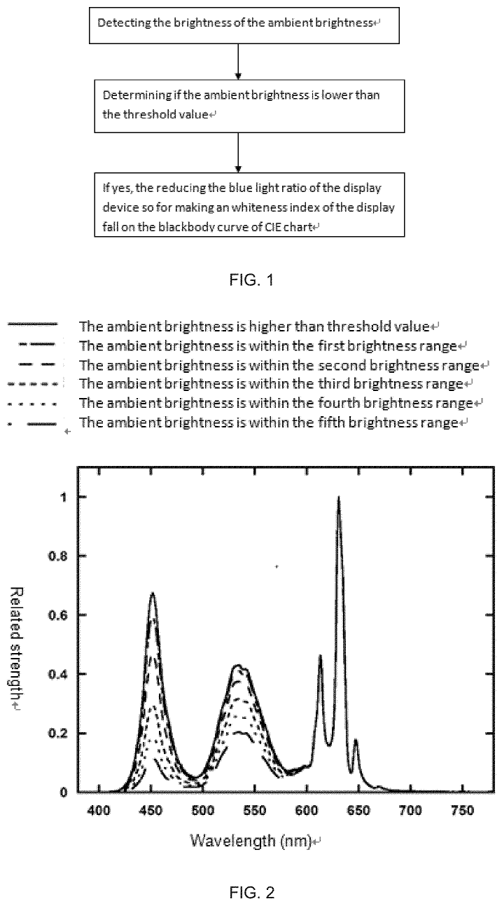

Referring to the Fig.1, the steps of reducing the blue light of a display device comprises in the present embodiment comprises:

S1: Detecting the brightness of the ambient light. The ambient light comprises three situations. In the first case, the display is located outdoors and the ambient light is highlighted ambient light. In the second case, the display is located indoors and the ambient light is the indoor ambient light. The third is the display is located in low light environment or darkroom environment, and the ambient light is low-light ambient light.

S2: Detecting if the ambient brightness is lower than a threshold value. It is better that the threshold value in the present embodiment is 500 lux, which means to detect the ambient brightness is lower than 500 lux. Of course, it can be adjusted depending on the real situation, for example, it can chose different threshold value according to the performance of the display.

S3: Reducing a blue light ratio of the display device if the ambient brightness is lower than the threshold value for making an whiteness index of the display fall on the blackbody curve of CIE chart. It means that the display is located in indoors, low light environment or darkroom environment if the ambient brightness is lower than 500 lux to reducing the blue light ratio of the display device. It also makes the whiteness index of the display fall on the blackbody curve of CIE chart when reducing the blue light ratio at the same time. Since the CIE chart located on the blackbody curve or the white index in the range around the blackbody curve are suitable for human eye, human eye does not have the obvious color cast of the white light around the range. It becomes to protect the eye and deducing the color cast of human eye at the same time.

If the ambient lightness is not lower than the threshold values in S3, it means the display is located in outdoors which does not change the blue ratio of the display device.

Specifically, S3 further comprises:

S31: determining the ambient brightness is within a first brightness range and lowering the blue light ratio of the display device to a first ratio when the ambient brightness is tot first brightness range;

S32: determining the ambient brightness is within a second brightness range and lowering the blue light ratio of the display device to a second ratio when the ambient brightness is within the second brightness range;

S33: determining the ambient brightness is within a third brightness range and lowering the blue light ratio of the display device to a third ratio when the ambient brightness is within the third brightness range;

S34: determining the ambient brightness is within a fourth brightness range and lowering the blue light ratio of the display device to a fourth ratio when the ambient brightness is within the fourth brightness range;

S35: determining the ambient brightness is within a fifth brightness range and lowering the blue light ratio of the display device to a fifth ratio when the ambient brightness is within the first brightness range.

In S3, by dividing the brightness of the ambient light into five intervals, the blue light ratio of the display may be adjusted to different degrees with respect to the brightness of different ambient light. It increases the accuracy of the method for reducing the blue light of the display in this embodiment and improve the performance of the display. Of course, it is not limited to five intervals, and it also can be set according to the needs of more brightness interval which further improve the monitor's blue light than the regulation accuracy.

Since the light comprising the blue light and the green light, mainly on the light of the attached blue light, are more harmful to human eyes. The present embodiment reduces the brightness of the blue light and the green light while adjusting the blue light ratio, so that the light emitted by the display. The white index coordinates of the display are located on the blackbody curve of the CIE chart and does not harm the human eye.

Specifically, the method further comprises:

the step of lowering the blue light ratio of the display device to the first ratio when the ambient brightness is within the first brightness range which further comprises lowering the brightness of blue light of the display device to a first brightness and lowering the of a green light of the display device a second brightness;

the step of lowering the blue light ratio of the display device to the second ratio when the ambient brightness is within the second brightness range which further comprises lowering the brightness of blue light of the display device to a third brightness and lowering the of a green light of the display device a fourth brightness;

the step of lowering the blue light ratio of the display device to the third ratio when the ambient brightness is within the third brightness range which further comprises lowering the brightness of blue light of the display device to a fifth brightness and lowering the of a green light of the display device a sixth brightness;

the step of lowering the blue light ratio of the display device to the fourth ratio when the ambient brightness is within the fourth brightness range which further comprises lowering the brightness of blue light of the display device to a seventh brightness and lowering the of a green light of the display device a eighth brightness; and

wherein the step of lowering the blue light ratio of the display device to the fifth ratio when the ambient brightness is within the fifth brightness range which further comprises lowering the brightness of blue light of the display device to a ninth brightness and lowering the of a green light of the display device a tenth brightness;

The blue light of the display device with the wavelength is in the range of 430 nm-480 nm and the green light of the display device with the wavelength is in the range of 510 nm-570 nm. Reducing the brightness of the blue light is reducing the brightness of the wavelength located in 430 nm˜480 nm. Reducing the brightness of the green light is reducing the brightness of the wavelength located in 510 nm˜570 nm.

In the present embodiment, the first brightness range is 300-500 lux. The second brightness range is 100-300 lux. The third brightness range is 50-100 lux. The fourth brightness range is 10-50 lux and the fifth brightness range is 0-10 lux.

The first ratio is 2.93%. The second ratio is 2.56%. The third ratio is 1.94%. The fourth ratio is 1.44% and the fifth ratio is 1.06%.

The first brightness is 0.87-0.95 time of the brightness of the blue light of the display. The second brightness is 0.93-0.95 time of the brightness of the green light of the display. The third brightness is 0.69-0.7 time of the brightness of the blue light of the display. The fourth brightness is 0.86-0.88 time of the brightness of the green light of the display. The fifth brightness is 0.43-0.48 time of the brightness of the blue light of the display. The sixth brightness is 0.67-0.75 time of the brightness of the green light of the display. The seventh brightness is 0.27-0.32 time of the brightness of the blue light of the display. The eighth brightness is 0.55-0.61 time of the brightness of the green light of the display. The ninth brightness is 0.17-0.22 time of the brightness of the blue light of the display; and the tenth brightness is 0.43-0.48 time of the brightness of the green light of the display.

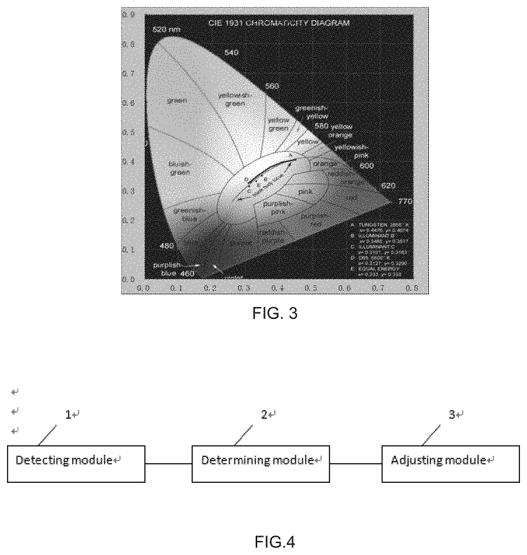

When the ambient lightness is 300˜500 lux, the blue light ratio of the display device is 2.93%. The brightness of blue light is 0.87˜0.92 time of the original blue light, and the brightness of green light is 0.93˜0.95 time of the original green light. When the ambient lightness is 100˜300 lux, the blue light ratio of the display device is 2.56%. The brightness of blue light is 0.69˜0.7 time of the original blue light, and the brightness of green light is 0.86˜0.88 time of the original green light. When the ambient lightness is 50˜100 lux, the blue light ratio of the display device is 1.94%. The brightness of blue light is 0.43˜0.48 time of the original blue light, and the brightness of green light is 0.67˜0.75 time of the original green light. When the ambient lightness is 10˜50 lux, the blue light ratio of the display device is 1.44%. The brightness of blue light is 0.27˜0.32 time of the original blue light, and the brightness of green light is 0.55˜0.61 time of the original green light. When the ambient lightness is 0˜10 lux, the blue light ratio of the display device is 1.06%. The brightness of blue light is 0.17˜0.22 time of the original blue light, and the brightness of green light is 0.43˜0.48 time of the original green light. The FIG. 2 shows that the brightness of the ambient lightness is within the first brightness range, the second brightness range, the third brightness range, the fourth brightness range and the fifth brightness range. The different brightness of the wavelength is corresponding to the display device which is adjusted. The FIG. 3 shows the trace of the whiteness index which is adjusted by the display device. It shows that the ambient brightness is within the first brightness range, the second brightness range, the third brightness range, the fourth brightness range and the fifth brightness range. All the white index of the adjusted display device are located on the blackbody curve of the CIE chart (as the A⋅B⋅C⋅D⋅E of FIG. 3)

Referring to FIG. 4, the low blue light display in the present embodiment comprise the detecting module 1, determining module 2 and adjusting module 3. The detecting module 1 is used for detecting an ambient brightness. The determining module 2 is used for determining if the ambient brightness is lower than a threshold value. The adjusting module 3 is used for lower a blue light ratio of the display device when the ambient brightness is lower than the threshold value to make the whiteness index of the display device is on the blackbody curve of the CIE chart. The brightness and the blue light ratio are adjusted through the pixel voltage and the brightness of backlight in the adjusting module 3.

The above descriptions are merely specific implementation manners of the present application. It should be noted that those skilled in the art may make some improvements and modifications without departing from the principle of the present application. These improvements and modifications should be regarded as the scope of protection of this application.

What is claimed is:

1. A display method of reducing the blue light of a display device, comprising the steps of:
detecting an ambient brightness;
determining if the ambient brightness is lower than a threshold value;
reducing a blue light ratio of the display device if the ambient brightness is lower than the threshold value for making an whiteness index of the display fall on the blackbody curve of CIE chart.

2. The display method according to claim 1, wherein the step of reducing the blue light ratio if the ambient brightness is lower than the threshold value further comprises:
determining the ambient brightness is within a first brightness range, lowering the blue light ratio of the display device to a first ratio when the ambient brightness is tot first brightness range;
determining the ambient brightness is within a second brightness range, lowering the blue light ratio of the display device to a second ratio when the ambient brightness is within the second brightness range;
determining the ambient brightness is within a third brightness range, lowering the blue light ratio of the display device to a third ratio when the ambient brightness is within the third brightness range;
determining the ambient brightness is within a fourth brightness range, lowering the blue light ratio of the display device to a fourth ratio when the ambient brightness is within the fourth brightness range; and
determining the ambient brightness is within a fifth brightness range, lowering the blue light ratio of the display device to a fifth ratio when the ambient brightness is within the first brightness range.

3. The method according to claim 2, wherein the step of lowering the blue light ratio of the display device to the first ratio when the ambient brightness is within the first brightness range further comprises lowering the brightness of blue light of the display device to a first brightness and lowering the of a green light of the display device a second brightness;
wherein the step of lowering the blue light ratio of the display device to the second ratio when the ambient brightness is within the second brightness range further comprises lowering the brightness of blue light of the display device to a third brightness and lowering the of a green light of the display device a fourth brightness;
wherein the step of lowering the blue light ratio of the display device to the third ratio when the ambient brightness is within the third brightness range further comprises lowering the brightness of blue light of the display device to a fifth brightness and lowering the of a green light of the display device a sixth brightness;
wherein the step of lowering the blue light ratio of the display device to the fourth ratio when the ambient brightness is within the fourth brightness range further comprises lowering the brightness of blue light of the display device to a seventh brightness and lowering the of a green light of the display device a eighth brightness; and
wherein the step of lowering the blue light ratio of the display device to the fifth ratio when the ambient brightness is within the fifth brightness range further comprises lowering the brightness of blue light of the display device to a ninth brightness and lowering the of a green light of the display device a tenth brightness.

4. The method according to claim 3, wherein the blue light of the display device with the wavelength in the range of 430 nm-480 nm and wherein the green light of the display device with the wavelength in the range of 510 nm-570 nm.

5. The method according to claim 3, the first brightness range is 300-500 lux, the second brightness range is 100-300 lux, the third brightness range is 50-100 lux, the fourth brightness range is 10-50 lux and the fifth brightness range is 0-10 lux.

6. The method according to claim 5, the first ratio is 2.93%, the second ratio is 2.56%, the third ratio is 1.94%, the fourth ratio is 1.44% and the fifth ratio is 1.06%.

7. The method according claim 5, wherein the first brightness is 0.87-0.95 time of the brightness of the blue light of the display; the second brightness is 0.93-0.95 time of the brightness of the green light of the display; the third brightness is 0.69-0.7 time of the brightness of the blue light of the display; the fourth brightness is 0.86-0.88 time of the brightness of the green light of the display; the fifth brightness is 0.43-0.48 time of the brightness of the blue light of the display; the sixth brightness is 0.67-0.75 time of the brightness of the green light of the display; the seventh brightness is 0.27-0.32 time of the brightness of the blue light of the display; the eighth brightness is 0.55-0.61 time of the brightness of the green light of the display; the ninth brightness is 0.17-0.22 time of the brightness of the blue light of the display; and the tenth brightness is 0.43-0.48 time of the brightness of the green light of the display.

8. The method according to claim 1, wherein the threshold value is 500 lux.

9. A low blue light display device, comprising:
a detecting module, used for detecting an ambient brightness;
a determining module, used for determining if the ambient brightness is lower than a threshold value;
a adjusting module, used for lowering a blue light ratio of the display device when the ambient brightness is lower than the threshold value to make the whiteness index of the display device is on the blackbody curve of the CIE chart.
